(19) United States
(12) Patent Application Publication
(10) Pub. No.: US 2026/0195153 A1
(43) Pub. Date: Jul. 9, 2026

(54) INTERACTION CUSTOMIZATION BASED ON USER ACCESSIBILITY NEEDS

(71) Applicant: International Business Machines Corporation, Armonk, NY (US)

(72) Inventors: Susann Marie Keohane, Austin, TX (US); Jessica Murillo, Round Rock, TX (US); Johnny Shieh, Austin, TX (US)

(21) Appl. No.: 19/012,913

(22) Filed: Jan. 8, 2025

(51) Int. Cl. G06F 9/451; H04L 67/306

(52) U.S. Cl. CPC G06F 9/453; H04L 67/306

(57) ABSTRACT

Customization of interactions for improved accessibility includes receiving input data having a set of accessibility preferences associated with a user. A user profile of the user is linked with a set of customer profiles of the user based on the input data. The set of customer profiles is associated with a set of merchant entities. An engagement between the first user and a first interactor associated with a first merchant entity of the set of merchant entities is detected. A machine learning (ML) model is applied to the input data and merchant data associated with the first merchant entity. A set of instructions is generated to customize an interaction between the user and the first interactor. The first set of instructions is rendered to the first interactor to customize the interaction.

### BACKGROUND

The disclosure relates to improving accessibility and more particularly, to interaction customization based on user accessibility needs.

Integration of technology with customer service interactions is ideal to meet the diverse needs of users with disabilities. Often many service environments currently lack the required frameworks to effectively accommodate varying requirements of the users with disabilities, leading to significant challenges in communication and service delivery. This situation not only creates barriers for users with disabilities but also affects users with unrecognized accessibility needs, such as the elderly or those with temporary impairments. Existing systems often depend on the users with disabilities to communicate their accessibility requirements, resulting in inefficient and uncomfortable interactions. Such dependence can induce frustration and feelings of exclusion, while also limiting opportunities for service providers to engage effectively with a broader customer base.

### SUMMARY

According to an embodiment of the disclosure, a computer-implemented method for interaction customization based on user accessibility needs. The computer-implemented method includes receiving, by a computer, input data including a set of accessibility preferences associated with a first user of a set of users. The computer-implemented method further includes linking, by the computer, a user profile of the first user with a set of customer profiles of the first user based on the input data. The set of customer profiles is associated with a set of merchant entities. The computer-implemented method further includes detecting, by the computer, a first engagement between the first user and a first interactor. The first interactor is associated with a first merchant entity of the set of merchant entities based on the linking of the user profile and the set of customer profiles. The computer-implemented method further includes applying, by the computer, a first machine learning (ML) model on the input data and first merchant data. The first merchant data is associated with the first merchant entity. The computer-implemented method further includes generating, by the computer, a first set of instructions based on the application of the first ML model on the input data and the first merchant data. The first set of instructions is generated for customization of a first interaction between the first user and the first interactor by the first interactor. The computer-implemented method further includes rendering, by the computer, the first set of instructions to the first interactor for the customization of the first interaction.

According to one or more embodiments of the disclosure, a computer system is described. The computer system includes a processor set, one or more computer-readable storage media, and program instructions stored on the one or more computer-readable storage media. The program instructions executable by the processor set to cause the processor set to perform a method for interaction customization based on user accessibility needs. The program instructions further cause the processor set to receive input data including a set of accessibility preferences associated with a first user of a set of users. The program instructions further cause the processor set to link a user profile of the first user with a set of customer profiles of the first user based on the input data. The set of customer profiles is associated with a set of merchant entities. The program instructions further cause the processor set to determine a first location of a first user device associated with the first user is within a threshold distance of a second location of a first interactor associated with a first merchant entity of the set of merchant entities. The determination that the first location is within the threshold distance of the second location is based on the linking of the user profile and set of customer profiles. The program instructions further cause the processor set to apply a first machine learning (ML) model on the input data and first merchant data. The first merchant data is associated with the first merchant entity. Further, the program instructions cause the processor set to generate a first set of instructions based on the application of the first ML model on the input data and the first merchant data. The first set of instructions is generated for customization of a first interaction between the first user and the first interactor by the first interactor. Additionally, the program instructions further cause the processor set to render the set of instructions to the first interactor for the customization of the first interaction.

According to one or more embodiments of the disclosure, a computer-program product is described. The computer-program product includes one or more computer-readable storage media and program instructions stored on the one or more computer-readable storage media to perform operations for interaction customization based on user accessibility needs. The operations include receiving input data including a set of accessibility preferences associated with a first user of a set of users. The operations further include linking a user profile of the first user with a set of customer profiles of the first user based on the input data. The set of customer profiles is associated with a set of merchant entities. The operations further include detecting a first engagement between the first user and a first interactor. The first interactor is associated with a first merchant entity of the set of merchant entities based on the linking of the user profile and the set of customer profiles. The operations further include applying a first machine learning (ML) model on the input data and first merchant data. The first merchant data is associated with the first merchant entity. The operations further include generating a first set of instructions based on the application of the first ML model on the input data and the first merchant data. The first set of instructions is generated for customization of a first interaction between the first user and the first interactor by the first interactor. The operations further include rendering the first set of instructions to the first interactor for the customization of the first interaction.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the execution of at least some of the computer code involved in performing the disclosed methods, such as interaction customization based on user accessibility needs, in accordance with an embodiment of the disclosure;

FIG. 2 is a diagram that illustrates an environment for interaction customization based on user accessibility needs, in accordance with an embodiment of the disclosure;

FIG. 3 is a diagram that illustrates exemplary operations for interaction customization based on user accessibility needs, in accordance with an embodiment of the disclosure;

FIG. 4 is a diagram that illustrates exemplary operations for generating one or more clusters of a set of users, in accordance with an embodiment of the disclosure;

FIG. 5A is a diagram that illustrates an exemplary user interface (UI) for interaction at a first time instance, in accordance with an embodiment of the disclosure;

FIG. 5B is a diagram that illustrates an exemplary customized UI for interaction at a second time instance, in accordance with an embodiment of the disclosure;

FIG. 6 is a diagram that illustrates an exemplary UI for interaction with recommendations, in accordance with an embodiment of the disclosure;

FIG. 7 is a diagram that illustrates a flowchart of an exemplary method for interaction customization based on user accessibility needs, in accordance with an embodiment of the disclosure; and

FIGS. 8A and 8B are diagrams that collectively illustrate a flowchart of an exemplary method for interaction customization based on feedback data, in accordance with an embodiment of the disclosure.

### DETAILED DESCRIPTION

Individuals with disabilities face substantial barriers in effectively communicating interactional requirements (such as voice-assisted checkout) when interacting with service interfaces or customer representatives. Further, the barriers may arise from a lack of universally accessible design in existing service interfaces that may not accommodate varying sensory impairments, cognitive impairments, motor impairments, and the like. For example, usual communication methods may rely on auditory or visual inputs and outputs, which may not be suitable for individuals with hearing, speech, or visual disabilities. Additionally, interactions with the customer representatives depend on verbal exchanges and are often rapid and brief which may pose difficulties and uncomfortable interactions for individuals with disabilities. Further, the lack of support measures for the individuals with disabilities may result in frequent miscommunication, transactional errors during the interactions, and delays.

To address these issues, there is a need for a system that can customize interactions (e.g., interactions between users and customer representatives) as per the preferences of users to improve the accessibility of the users. Such a system may leverage machine learning models and natural language processing to provide a set of instructions to merchant entities (e.g., service interfaces, customer representatives, and the like) to customize interactions between the users and the merchant entities as per the preferences of the users.

The disclosed system is configured to receive input data including a set of accessibility preferences associated with a user. Further, the system is configured to generate a user profile of the user based on the input data. The proposed system aims to link the user profile with a set of customer profiles of the user. The set of customer profiles may be associated with a set of merchant entities. Further, the proposed system aims to detect an engagement between the user and a merchant entity of the set of merchant entities. Upon detecting the engagement, the proposed system aims to apply a machine learning (ML) model on the input data and merchant data that corresponds to data associated with a merchant entity of the set of merchant entities. Based on the application of the ML model, the proposed system aims to generate a set of instructions to customize an interaction between the user and the merchant entity such that accessibility and communication associated with the interactions are improved.

The disclosed system utilizes machine learning algorithms to analyze user accessibility preferences and enhance interactions between the user and the merchant entity. By integrating the user profile with the set of customer profiles, the system identifies engagement patterns between the user and the merchant entity. Upon detecting these engagements, the disclosed system applies machine learning techniques to generate the set of instructions to customize the interaction. The disclosed system may provide personalized experience to the user without manual configuration by continuously refining and improving the machine learning algorithms based on feedback received from the user. This data-driven adaptability of the disclosed system ensures scalability and consistency in user experience across various merchant entities, thereby enhancing operational efficiency of the merchant entities. Additionally, the disclosed system may generate interaction report based on feedback of the interaction between the user and the merchant entity. The interaction reports may provide valuable insights to the merchant entities to implement targeted improvements toward the customer service approach, optimize the duration of interactions, and ensure that specific user requests are met, without manual intervention. Thus, the disclosed system offers greater scalability and adaptability for the merchant entities.

The disclosed system utilizes machine learning algorithms to analyze user accessibility preferences of users. By linking user profiles of the users with the set of customer profiles, the system identifies engagement patterns between the users and various merchant entities. Based on the identification of the engagement patterns, the disclosed system may customize interactions between the users and a variety of merchant entities. Therefore, the disclosed system can be deployed in a variety of merchant entities with any prior training. This significantly reduces the time required to deploy the disclosed system at new merchant entities as the disclosed system can leverage machine learning models that are pre-configured based on the analysis of the user accessibility preferences. Further, the disclosed system may generate one or more clusters using various machine learning algorithms such as K-means, Density-Based Spatial Clustering of Applications with Noise (DBSCAN), or hierarchical clustering, to group users based on the user accessibility preferences. The disclosed system may further retrieve feedback associated with the customized interactions and analyze patterns in user behavior, preferences, and interaction history to refine the generated one or more clusters based on user satisfaction and success rates of the interactions from the interaction history, thereby improving the customization of the interactions between the users and merchant entities. This data-driven adaptability of the disclosed system ensures scalability and adaptability for the customization of the interactions, thus enhancing operational efficiency of the merchant entities by minimizing repetitive data collection and manual intervention for the users. The disclosed system optimizes computational resources by processing aggregated data at cluster level rather than executing individual processing for each user. Thus, the disclosed system reduces computational overhead and conserve processing resources, enabling faster customization of the interactions and improving overall performance of the disclosed system. The disclosed system may further detect changes or trends within the one or more clusters and simultaneously apply updates across the entire cluster, ensuring efficient use of the computational resources by avoiding repetitive individual updates while maintain consistency and responsiveness to evolving patterns. Additionally, the disclosed system may generate interaction report based on the retrieved feedback. The interaction reports may provide valuable insights to the merchant entities to implement targeted improvements toward the customer service approach and optimize the duration of interactions to improve user satisfaction.

According to an embodiment of the disclosure, a computer-implemented method for interaction customization based on user accessibility needs. The computer-implemented method includes receiving, by a computer, input data including a set of accessibility preferences associated with the first user of a set of users. The computer-implemented method further includes linking, by the computer, a user profile of the first user with a set of customer profiles of the first user based on the input data. The set of customer profiles is associated with a set of merchant entities. The computer-implemented method further includes detecting, by the computer, a first engagement between the first user and a first interactor. The first interactor is associated with a first merchant entity of the set of merchant entities based on the linking of the user profile and the set of customer profiles. The computer-implemented method further includes applying, by the computer, a first machine learning (ML) model on the input data and first merchant data. The first merchant data is associated with the first merchant entity. The computer-implemented method further includes generating, by the computer, a first set of instructions based on the application of the first ML model on the input data and the first merchant data. The first set of instructions is generated for customization of a first interaction between the first user and the first interactor by the first interactor. The computer-implemented method further includes rendering, by the computer, the first set of instructions to the first interactor for the customization of the first interaction.

In various embodiments of the disclosure, the computer-implemented method further includes receiving, by the computer, a first feedback based on the first interaction. The computer-implemented method further includes training, by the computer, the first ML model on the first feedback and the first set of instructions. The computer-implemented method further includes generating, by the computer, a second set of instructions based on the training of the first ML model on the first feedback and the first set of instructions. The second set of instructions is generated for customization of a second interaction between the first user and at least one of the first interactor or a second interactor by the at least one of the first interactor or the second interactor. The second interactor is associated with a second merchant entity of the set of merchant entities.

In various embodiments of the disclosure, the computer-implemented method further includes detecting, by the computer, a second engagement between the first user and the at least one of the first interactor or the second interactor. The second interactor is associated with a second merchant entity of the set of merchant entities. The computer-implemented method further includes applying, by the computer, the trained first ML model on the input data and at least one of the first merchant data or second merchant data. The second merchant data is associated with the second merchant entity. The computer-implemented method further includes generating, by the computer, the second set of instructions based on the application of the trained first ML model on the input data and the at least one of the first merchant data or the second merchant data. The computer-implemented method further includes rendering, by the computer, the second set of instructions to the at least one of the first interactor or the second interactor for the customization of the second interaction.

In various embodiments of the disclosure, the computer-implemented method further includes generating, by the computer, an interaction report based on the first feedback. The computer-implemented method further includes transmitting, by the computer, the interaction report to a first electronic device associated with the first merchant entity.

In various embodiments of the disclosure, the interaction report includes at least one of a rating associated with the first interaction, a duration of the first interaction, one or more suggestions for improvement of the second interaction, or one or more special requests associated with the first user.

In various embodiments of the disclosure, the computer-implemented method further includes receiving, by the computer, first location data indicative of a first location of the first user device. The first user device is associated with the first user. The computer-implemented method further includes receiving, by the computer, second location data indicative of a second location of the first interactor. The computer-implemented method further includes determining, by computer, the first location is within a threshold distance of the second location. The computer-implemented method further includes detecting, by the computer, the first engagement between the first user and the first interactor based on the determination that the first location is within the threshold distance of the second location.

In various embodiments of the disclosure, the computer-implemented method further includes determining, by the computer, a usage of one or more credentials associated with the first user in at least one of a brick-and-mortar store or an application associated with the first merchant entity. The computer-implemented method further includes detecting, by the computer, the first engagement between the first user and the first interactor based on the determination of the usage of the one or more credentials.

In various embodiments of the disclosure, the computer-implemented method further includes determining, by the computer, that the first interactor corresponds to an automated system. The computer-implemented method further includes generating, by the computer, the first set of instructions based on the determination that the first interactor corresponds to the automated system. The computer-implemented method further includes controlling, by the computer, an interface of the automated system based on the first set of instructions. The interface is controlled for the customization of the first interaction.

In various embodiments of the disclosure, the computer-implemented method further includes determining, by the computer, that the first interactor corresponds to an operator. The computer-implemented method further includes generating, by the computer, the first set of instructions based on the determination that the first interactor corresponds to the operator. The computer-implemented method further includes rendering, by the computer, a set of recommendations for the operator based on the first set of instructions.

In various embodiments of the disclosure, the computer-implemented method further includes applying, by the computer, a second ML model on a set of input data including a plurality of accessibility preferences associated with the set of users. The computer-implemented method further includes generating, by the computer, one or more clusters from the set of users based on the application of the second ML model on the set of input data.

In various embodiments of the disclosure, the computer-implemented method further includes detecting, by the computer, a third engagement between a second user and the first interactor. The second user is different from the set of users. The computer-implemented method further includes identifying, by the computer, the second user is associated with a first cluster of the one or more clusters. The computer-implemented method further includes generating, by the computer, a third set of instructions based on the identification that the second user is associated with the first cluster. The third set of instructions is generated for customization of a third interaction between the second user and the first interactor by the first interactor. The computer-implemented method further includes rendering, by the computer, the third set of instructions to the first interactor for the customization of the third interaction.

In various embodiments of the disclosure, the computer-implemented method further includes analyzing, by the computer, a set of historical interactions associated with the first cluster of users upon the detection of the third engagement. The computer-implemented method further includes generating, by the computer, a set of suggestions for the second user based on the analysis of the interaction histories. The computer-implemented method further includes rendering, by the computer, the set of suggestions to a second user device associated with the second user.

In various embodiments of the disclosure, the set of suggestions includes at least one of a product suggestion, a preferred service option, a promotion, or an optimal duration for interaction.

According to one or more embodiments of the disclosure, a computer system is described. The computer system includes a processor set, one or more computer-readable storage media, and program instructions stored on the one or more computer-readable storage media. The program instructions executable by the processor set to cause the processor set to perform a method for interaction customization based on user accessibility. The program instructions further cause the processor set to receive input data including a set of accessibility preferences associated with a first user of a set of users. The program instructions further cause the processor set to link a user profile of the first user with a set of customer profiles of the first user based on the input data. The set of customer profiles is associated with a set of merchant entities. The program instructions further cause the processor set to determine a first location of a first user device associated with the first user is within a threshold distance of a second location of a first interactor associated with a first merchant entity of the set of merchant entities. The determination that the first location is within the threshold distance of the second location is based on the linking of the user profile and the set of customer profiles. The method further includes applying a first machine learning (ML) model on the input data and first merchant data. The first merchant data is associated with the first merchant entity. Further, the method includes generating a first set of instructions based on the application of the first ML model on the input data and the first merchant data. The first set of instructions is generated for customization of a first interaction between the first user and the first interactor by the first interactor. Additionally, the method includes rendering the set of instructions to the first interactor for the customization of the first interaction.

In various embodiments of the disclosure, the program instructions further cause the processor set to receive a first feedback generated based on the first interaction. The program instructions further cause the processor set to train the first ML model on the first feedback and the first set of instructions. The program instructions further cause the processor set to generate a second set of instructions based on the training of the first ML model on the first feedback and the first set of instructions. The second set of instructions is generated to customize a second interaction between the first user and a second interactor by the second interactor. The second interactor is associated with a second merchant entity of the set of merchant entities.

In various embodiments of the disclosure, the program instructions further cause the processor set to determine the first location is within the threshold distance of a third location of the second interactor. The determination that the first location is within the threshold distance of the third location is based on the linking of the user profile and the set of customer profiles. The program instructions further cause the processor set to apply the trained first ML model on the input data and second merchant data. The second merchant data is associated with the second merchant entity. The program instructions further cause the processor set to generate the second set of instructions based on the application of the trained first ML model on the input data and the second merchant data. The second set of instructions is generated for the customization of the second interaction between the first user and the second interactor. The program instructions further cause the processor set to render the second set of instructions to the second interactor for the customization of the second interaction.

In various embodiments of the disclosure, the program instructions further cause the processor set to generate an interaction report based on the first feedback. The program instructions further cause the processor set to transmit the interaction report to a first electronic device associated with the first merchant entity.

In various embodiments of the disclosure, the program instructions further cause the processor set to apply a second ML model on a set of input data including a plurality of accessibility preferences associated with the set of users. The program instructions further cause the processor set to generate one or more clusters from the set of users based on the application of the second ML model on the set of input data.

In various embodiments of the disclosure, the program instructions further include determining a fourth location of a second user is within the threshold distance of the second location. The second user is different from the set of users. The program instructions further include identifying the second user is associated with a first cluster of the one or more clusters. The program instructions further include generating a third set of instructions based on the identification that the second user is associated with the first cluster. The third set of instructions is generated for customization of a third interaction between the second user and the first interactor by the first interactor. The program instructions further include rendering the third set of instructions to the first merchant entity for the customization of the third interaction.

According to one or more embodiments of the disclosure, a computer-program product is described. The computer-program product includes one or more computer-readable storage media and program instructions stored on the one or more computer-readable storage media to perform operations for interaction customization based on user accessibility needs including receiving input data including a set of accessibility preferences associated with a first user of a set of users. The program instructions further include linking a user profile of the first user with a set of customer profiles of the first user based on the input data. The set of customer profiles is associated with a set of merchant entities. The program instructions further include detecting a first engagement between the first user and a first interactor. The first interactor is associated with a first merchant entity of the set of merchant entities based on the linking of the user profile and the set of customer profiles. The program instructions further include applying a first machine learning (ML) model on the input data and first merchant data. The first merchant data is associated with the first merchant entity. The program instructions further include generating a first set of instructions based on the application of the first ML model on the input data and the first merchant data. The first set of instructions is generated for customization of a first interaction between the first user and the first interactor by the first interactor. The program instructions further include rendering the first set of instructions to the first interactor for the customization of the first interaction.

Various aspects of the disclosure are described by narrative text, flowcharts, block diagrams of computer systems, and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

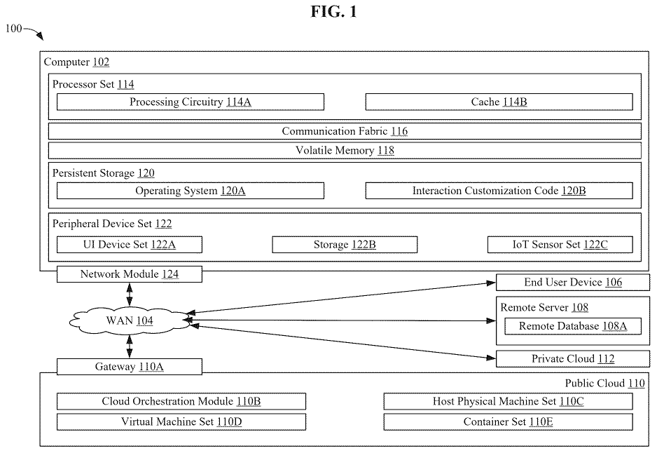

FIG. 1 is a diagram that illustrates a computing environment for interaction customization based on user accessibility needs, in accordance with an embodiment of the disclosure. With reference to FIG. 1, there is shown a computing environment 100 that contains an example of an environment for the execution of at least some of the computer code involved in performing the disclosed methods, such as interaction customization code 120B. In addition to the interaction customization code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the interaction customization code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or additional wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In alternate embodiment, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and additional storage media discussed below. The program instructions, and associated data, are accessed by the processor set 114 to control and direct the performance of the disclosed methods. In computing environment 100, at least some of the instructions for performing the disclosed methods may be stored in the dynamic modification of the interaction customization code 120B in persistent storage 120.

The communication fabric 116 is the signal conduction path that allows the various components of computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the interaction customization code 120B typically includes at least some of the computer code involved in performing the disclosed methods.

The peripheral device set 122 includes the set of peripheral devices of computer 102. Data communication connections between the peripheral devices and the additional components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with one or more computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or alternatively present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer-program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

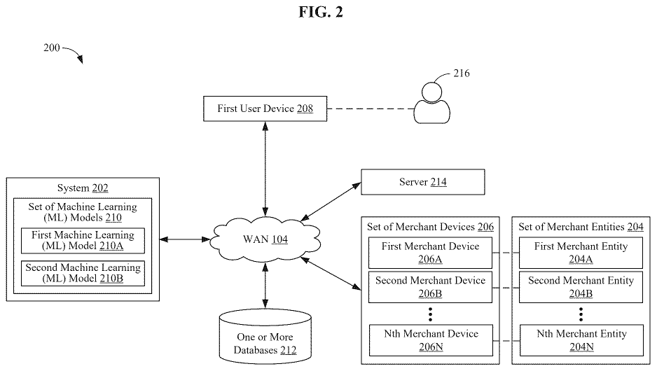

FIG. 2 is a diagram that illustrates an environment for interaction customization based on user accessibility needs, in accordance with an embodiment of the disclosure. FIG. 2 is explained in conjunction with elements from FIG. 1. With reference to FIG. 2, there is shown a diagram of a network environment 200. The network environment 200 includes a system 202, a set of merchant entities 204, a set of merchant devices 206, and a first user device 208. The system 202 includes a set of machine learning (ML) models 210. The network environment 200 further includes one or more databases 212, a server 214, a first user 216 associated with the first user device 208. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for interaction customization based on user accessibility needs for improved accessibility. The system 202 may be configured to receive input data including a set of accessibility preferences associated with the first user 216. In an embodiment, the first user 216 may correspond to a person with a disability (PwD) such that the set of accessibility preferences may correspond to a range of personalized requirements suitable for the first user 216 to accommodate specific needs and enhance usability. For example, a user with visual impairment may configure the set of accessibility preferences to utilize auditory feedback and larger text displays, while a user with motor impairment may select voice commands or adaptive switches. The set of accessibility preferences may include features such as alternative input methods, loud and clear speech articulation, simplified language, visual cues to enhance interaction, and the like.

The system 202 may be further configured to generate a first user profile based on the received input data. The first user profile may be specific to the first user 216 and may aggregate the set of accessibility preferences associated with the first user 216. Additionally, the first user profile may aggregate behavioral patterns, and individual needs into a comprehensive profile. Further, the first user profile may include attributes such as communication preferences of the first user 216, interaction modalities (e.g., touch, voice, gesture, and assistive technologies) associated with the first user 216, and the like. The system 202 may be further configured to link the first user profile of the first user 216 with a set of customer profiles of the first user 216. In an embodiment, the set of customer profiles may be associated with the set of merchant entities 204.

The set of merchant entities 204 may correspond to one or more distinct merchant entities, each representing individual businesses or organizations engaged in the sale of goods or services. The set of merchant entities 204 may vary in size and type, ranging from small local shops to large multinational corporations, and may operate in various sectors, including retail, hospitality, e-commerce, and the like. In an embodiment, each merchant entity of the set of merchant entities 204 may operate across multiple locations, regions, or platforms. As illustrated in the FIG. 2, the set of merchant entities 204 may include a first merchant entity 204A, a second merchant entity 204B, up to an Nth merchant entity 204N. In an embodiment, each merchant entity of the set of merchant entities 204 may operate independently. Additionally, the first merchant entity 204A may include a first interactor, and the second merchant entity 204B may include a second interactor. Similarly, the Nth merchant entity 204N may include an Nth interactor.

The set of merchant devices 206 may correspond to one or more distinct merchant devices of the set of merchant entities 204. As illustrated in the FIG. 2, the set of merchant devices 206 may include a first merchant device 206A, a second merchant device 206B, up to an Nth merchant device 206N. In an embodiment, the first merchant device 206A may be associated with the first merchant entity 204A, the second merchant device 206B may be associated with the second merchant entity 204B, and the Nth merchant device 206N may be associated with the Nth merchant entity 204N. The set of merchant devices 206 may include suitable logic, circuitry, interfaces, and/or code that may be configured to connect the set of merchant entities 204 to the WAN 104.

In an embodiment, the first interactor, the second interactor, and the Nth interactor may correspond to the first merchant device 206A, the second merchant device 206B, and the Nth merchant device 206N, respectively. Examples of the first merchant device 206A, the second merchant device 206B, and the Nth merchant device 206N may correspond to an automated system such as a kiosk. In an alternate embodiment, the first interactor, the second interactor, and the Nth interactor may correspond to an operator (e.g., a customer support staff at a cash counter) such that the first merchant device 206A, the second merchant device 206B, and the Nth merchant device 206N may correspond to a checkout device associated with the first interactor, the second interactor, and the Nth interactor, respectively.

The first merchant device 206A, the second merchant device 206B, and the Nth merchant device 206N may include merchant data associated with the first merchant entity 204A, the second merchant entity 204B, and the Nth merchant entity 204N, respectively. In an example, the first merchant device 206A may include first merchant data and the second merchant device 206B may include second merchant data. The first merchant data may be associated with the first merchant entity 204A and may correspond to information associated with a first automated system (e.g., the first merchant device 206A) of the first merchant entity 204A. Examples of the first automated system may include a kiosk, a point-of-sale, or an interactive display. In an embodiment, the first merchant data may include details about a type of the first automated system, a display size of the first automated system, a resolution of the first automated system, or a configuration of the first automated system. Additionally, the first merchant data may include details about a number of automated systems identical to the first automated system associated with the first merchant entity 204A and a number of operators associated with the first merchant entity 204A.

Similarly, the second merchant data may be associated with the second merchant entity 204B and may correspond to information associated with a second automated system (e.g., the second merchant device 206B) of the second merchant entity 204B. Examples of the second automated system may include a kiosk, a point-of-sale, or an interactive display. In an embodiment, the second merchant data may include details about a type of the second automated system, a display size of the second automated system, a resolution of the second automated system, or a configuration of the second automated system. Additionally, the second merchant data may include details about a number of automated systems identical to the second automated system associated with the second merchant entity 204B and a number of operators associated with the second merchant entity 204B. Additionally, the Nth merchant data may be associated with the Nth merchant entity 204N and may correspond to information associated with an Nth automated system (e.g., the Nth merchant device 206N) of the Nth merchant entity 204N.

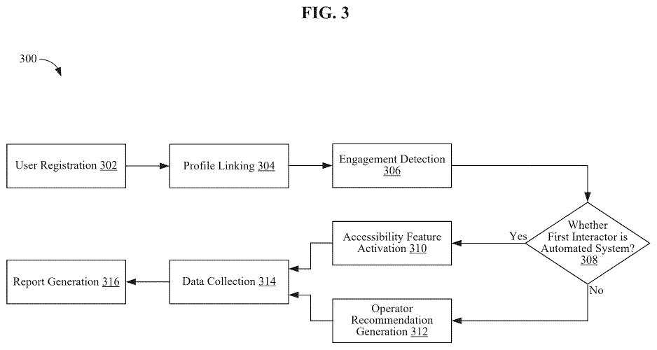

The system 202 may be further configured to detect a first engagement between the first user 216 and the first interactor. In an embodiment, the first engagement may correspond to an instance when the first user 216 initiates communication with the first interactor. For example, when the first interactor may correspond to the automated system (e.g., the first merchant device 206A), the first engagement may correspond to the first user 216 entering a merchant store associated with the first merchant entity 204A. Details about the detection of the first engagement between the first user 216 and the first interactor are provided, for example, in FIG. 3.

Upon detecting the first engagement, the system 202 may be further configured to receive the first merchant data from the first merchant entity 204A. The system 202 may be further configured to provide the input data and the first merchant data to a first machine learning (ML) model 210A of the set of ML models 210. The system 202 may be further configured to apply the first ML model 210A on the input data and the first merchant data to generate a first set of instructions. The system 202 may be further configured to render the first set of instructions to the first merchant entity 204A to customize a first interaction between the first user 216 and the first interactor. In an embodiment, the first interaction may correspond to an ongoing transaction between the first user 216 and the first interactor for the purchase of grocery items. Details about rendering the first set of instructions to the first merchant entity 204A are provided, for example, in FIG. 3.

The first user device 208 may include suitable logic, circuitry, interfaces, and/or code that may be configured to receive input data from the first user 216. The first user device 208 may be further configured to transmit the input data to the system 202. Additionally, the first user device 208 may be further configured to transmit the first location data indicative of the first location of the first user device 208 to the system 202. The first user device 208 may include a display screen. In an embodiment, the first user device 208 may be further configured to render a feedback toggle on the display screen based on the completion of the first interaction. Examples of the first user device 208 may include, but are not limited to, a smartphone, a cellular phone, a mobile phone, a computing device, a membership card associated with at least one of the set of merchant entities 204, and the like.

The display screen may include suitable logic, circuitry, and interfaces that may be configured to render the feedback toggle on the display screen. In an embodiment of the disclosure, the display screen may be an external display device associated with the first user device 208. The display screen may be a touch screen which may enable the first user 216 to provide the input data via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or additional display devices.

The first ML model 210A may be a computational network or a system of artificial neurons, arranged in a plurality of layers, as nodes. The plurality of layers of the first ML model 210A may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in one or more layers of the first ML model 210A. Outputs of each hidden layer may be coupled to inputs of at least one node in one or more layers of the first ML model 210A. Node(s) in the final layer may receive inputs from at least one hidden layer to output a result. The number of layers and the number of nodes in each layer may be determined from hyper-parameters of the first ML model 210A. Such hyper-parameters may be set before or while training the first ML model 210A on a training dataset.

Each node of the first ML model 210A may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in one or more layer (e.g., previous layer(s)) of the first ML model 210A. All or some of the nodes of the first ML model 210A may correspond to the same or a different mathematical function.

During the training of the first ML model 210A, one or more parameters of each node of the first ML model 210A may be updated based on whether an output of the final layer for a given input (from the training dataset) matches a correct result based on a loss function for the first ML model 210A. The above process may be repeated for the same or a different input until a minima of loss function may be achieved, and a training error may be minimized. Several methods for training are known in the art, for example, gradient descent, stochastic gradient descent, batch gradient descent, gradient boost, meta-heuristics, and the like.

The first ML model 210A may include electronic data, such as, for example, a software program, code of the software program, libraries, applications, scripts, or additional logic or instructions for execution by a processing device, such as the processor set 114. The first ML model 210A may include code and routines configured to enable a computing device, such as the system 202, to perform one or more operations. Additionally, or alternatively, the first ML model 210A may be implemented using hardware including a processor, a microprocessor (e.g., to perform or control the performance of one or more operations), a field-programmable gate array (FPGA), or an application-specific integrated circuit (ASIC). Alternatively, in some embodiments, the first ML model 210A may be implemented using a combination of hardware and software. Although in FIG. 2, the first ML model 210A is shown as a separate entity from the system 202, the disclosure is not so limited. Accordingly, in some embodiments, the first ML model 210A may be integrated within the system 202, without deviation from the scope of the disclosure. In an embodiment, the first ML model 210A may be stored in the server 214. Examples of the first ML model 210A may include, but are not limited to, a deep neural network (DNN), a convolutional neural network (CNN), a CNN-recurrent neural network (CNN-RNN), an artificial neural network (ANN), a fully connected neural network, and/or a combination of such networks.

In an embodiment, a second ML model 210B of the set of ML models 210 may correspond to a computer-based system or software that employs supervised or unsupervised machine learning techniques to analyze user data associated with the set of users. Examples of the user data may include age, gender, location, transaction history, spending patterns, and the like. The second ML model 210B may segment the set of users into distinct groups based on shared characteristics and behaviors to generate one or more cluster from the set of users. The second ML model 210B is designed to identify patterns within the user data that may improve user experiences and enhance personalization.

In an embodiment, the second ML model 210B may utilize advanced clustering algorithms, such as K-means or hierarchical clustering, to group users exhibiting similar attributes, such as age criteria, identical disabilities, demographic information, purchasing behaviors, and engagement metrics. Certain characteristics of the clustering model may include, but are not limited to, similarity measurement, cohort identification, pattern recognition, and knowledge transfer. For example, the second ML model 210B may generate the one or more clusters such as 40-50 age group, 50-60 age group, and the like to generate instructions (e.g., a set of instructions) for users without any accessibility preferences.

The one or more databases 212 may correspond to an organized collection of data that may be stored and accessed electronically from a computer system (such as the system 202). In an embodiment, the one or more databases 212 may store the user data (e.g., the first user data). In an embodiment, the one or more databases 212 may be configured to receive the user data from the respective user device of the set of users. The one or more databases 212 may be designed to manage, store, retrieve, and update the user data efficiently. The structure of the one or more databases 212 typically involves tables, records, and fields that can be managed through various database management systems (DBMS). Examples of the one or more databases 212 may include, but are not limited to, a relational database, a Non-Structured Query Language (NoSQL) database, a hierarchical database, a network database, a transactional database, a data warehouse, a distributed database, and the like.

The server 214 may include suitable logic, circuitry, and interfaces, and/or code that may be configured to receive the input data from the first user device 208. Upon receiving the input data, the server 214 may be further configured to store the input data. In an embodiment, the server 214 may be configured to store the first ML model 210A and the second ML model 210B. The server 214 may be implemented as a cloud server and may execute operations through web applications, cloud applications, HTTP requests, repository operations, file transfer, and the like. Additional example implementations of the server 214 may include, but are not limited to, a database server, a file server, a web server, a media server, an application server, a mainframe server, or a cloud computing server.

In an embodiment of the disclosure, the server 214 may be implemented as a plurality of distributed cloud-based resources by use of several technologies that are well known to those ordinarily skilled in the art. A person with ordinary skill in the art will understand that the scope of the disclosure may not be limited to the implementation of the server 214 and the system 202 as two separate entities. In certain embodiments, the functionalities of the server 214 can be incorporated in its entirety or at least partially in the system 202, without a departure from the scope of the disclosure.

In operation, the system 202 may be configured to receive the input data including the set of accessibility preferences associated with the first user 216. The system 202 may be further configured to generate the first user profile based on the received input data. The system 202 may be further configured to link the first user profile of the first user 216 with the set of customer profiles of the first user 216. The system 202 may be further configured to detect the first engagement between the first user 216 and the first interactor associated with the first merchant entity 204A of the set of merchant entities 204.

In an embodiment, the system 202 may be further configured to receive first location data indicative of a first location of the first user device 208. Further, the system 202 may be configured to receive second location data indicative of a second location of the first interactor. The system 202 may be further configured to determine the first location is within a threshold distance of the second location to detect the first engagement between the first user 216 and the first interactor. In various embodiments, the system 202 may be further configured to determine usage of one or more credentials associated with the first user 216 in at least one of a brick-and-mortar store or an application associated with the first merchant entity 204A to detect the first engagement between the first user 216 and the first interactor based on the determination of the usage of the one or more credentials.

The system 202 may be further configured to receive the first merchant data from the first merchant entity 204A. The system 202 may be further configured to provide the input data and the first merchant data to the first ML model 210A. The system 202 may be further configured to apply the first ML model 210A on the input data and the first merchant data to generate the first set of instructions. Further, the system 202 may be configured to render the first set of instructions to the first interactor to customize the first interaction between the first user 216 and the first interactor.

In an embodiment, the system 202 may be further configured to identify that the first interactor corresponds to the first automated system. The system 202 may be further configured to generate the first set of instructions based on the identification that the first interactor corresponds to the automated system. Additionally, the system 202 may be further configured to control an interface of the first automated system based on the first set of instructions. The interface may be controlled to customize the first interaction. For example, controlling the interface of the first automated system may correspond to increasing the font size of text displayed on the interface to improve the readability of the first user 216, when the set of accessibility preferences of the first user 216 corresponds to larger text due to visual impairments.

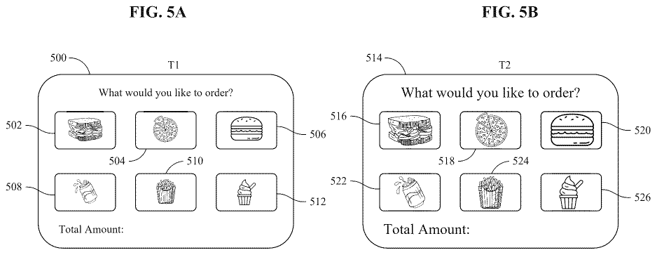

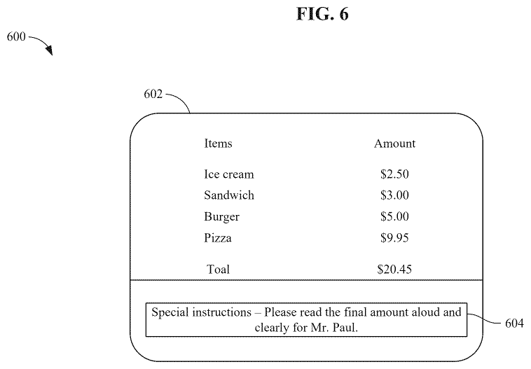

In an embodiment, the system 202 may be further configured to identify that the first interactor corresponds to the operator. The system 202 may be further configured to generate the first set of instructions based on the identification that the first interactor corresponds to the operator. Additionally, the system 202 may be further configured to render a set of recommendations to the operator. The set of recommendations may be rendered based on the first set of instructions to be followed by the operator to customize the first interaction. Examples of the set of recommendations are provided, for example, in FIG. 5.

The system 202 may be further configured to receive first feedback based on the first interaction. In an embodiment, the first feedback may be generated by the first user 216 and may correspond to the satisfaction of the first user 216 based on the first interaction. Further, the system 202 may be configured to train the first ML model 210A on the first feedback and the first set of instructions.

The system 202 may be further configured to generate an interaction report based on the first feedback. The system 202 may be further configured to transmit the interaction report to a first electronic device associated with the first merchant entity 204A. Examples of the first electronic device may include a smartphone, a computer, a point-of-sale terminal, and the like. In an embodiment, the interaction report may include at least one of the ratings associated with the first interaction, the duration of the first interaction, one or more suggestions for improvement of the second interaction, and one or more special requests associated with the first user 216. In additional embodiments, the interaction report may include the historical data to identify trends over time, thereby allowing the set of merchant entities (e.g., the first merchant entity 204A) to adapt various sales and customer acquisition strategies effectively. Further, the interaction reports may provide valuable insights to the set of merchant entities to implement targeted improvements toward the customer service approach, optimize the duration of interactions, and ensure that specific user requests are met, without manual intervention. Thus, the system 202 offers greater scalability and adaptability for the set of merchant entities.

The system 202 may be further configured to detect a second engagement between the first user 216 and at least one of the first interactor or the second interactor. Upon detecting the second engagement, the system 202 may be further configured to generate a second set of instructions based on the training of the first ML model 210A on the first feedback and the first set of instructions. The second set of instructions is generated to customize the second interaction between the first user 216 and at least one merchant entity of the set of merchant entities 204. In alternate words, the system 202 generates the second set of instructions to improve upcoming interactions (such as the second interaction) between the first user 216 and at least one merchant entity of the set of merchant entities 204. Additionally, the system 202 may be further configured to render the second set of instructions to at least one of the first interactor or the second interactor to customize the second interaction between the first user 216 and the at least one of the first instructor or the second interactor.

In an embodiment, when the second engagement is between the first user 216 and the second interactor, the system 202 may be configured to receive third location data. The third location data may be indicative of a third location of the second interactor. Further, the system 202 may be configured to determine the first location of the first user device 208 is within the threshold distance of the third location thereby detecting the second engagement. Further, the system 202 may be configured to apply the trained first ML model 210A on the input data and the second merchant data.

The system 202 may be further configured to apply the second ML model 210B on a set of input data including a plurality of accessibility preferences associated with the set of users. The system 202 may be further configured to generate the one or more clusters from the set of users based on the application of the second ML model 210B on the set of input data. Further, the system 202 may be configured to detect a third engagement between a second user and the first interactor. In an embodiment, the system 202 may be configured to receive fourth location data indicative of a fourth location of the second user. Further, the system 202 may be configured to determine that the fourth location is within the threshold distance of the second location of the first interactor thereby detecting the first engagement. In an embodiment, the second user may correspond to a user without any set of accessibility preferences. Further, the second user may be different from the set of users. The system 202 may be further configured to identify that the second user is associated with a first cluster of the one or more clusters. Further, the system 202 may be configured to generate a third set of instructions based on the identification that the second user is associated with the first cluster. Additionally, the system 202 may be configured to render the third set of instructions to the first merchant entity 204A to customize a third interaction between the second user and the first interactor.

In an embodiment, the system 202 may be further configured to analyze a set of historical interactions associated with the first cluster of users upon the detection of the third engagement. The system 202 may be further configured to generate a set of suggestions for the second user based on the analysis of the interaction histories. The system 202 may be further configured to render the set of suggestions to a second user device associated with the second user.

FIG. 3 is a diagram that illustrates exemplary operations for interaction customization based on user accessibility needs, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 316, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a user registration operation may be executed. In the user registration operation, the first user device 208 may configured to receive the input data from the first user 216. The input data includes the set of accessibility preferences associated with the first user 216 of the set of users. In an embodiment, the first user 216 may correspond to a person with a disability (PwD) such that the set of accessibility preferences may correspond to a range of personalized requirements suitable for the first user 216 to accommodate specific needs (e.g., poor vision, loss of hearing, and the like) and enhances usability. The first user device 208 may be further configured to transmit the input data to the system 202.

The system 202 may be configured to receive the input data including the set of accessibility preferences associated with the first user 216. The system 202 may be further configured to generate the first user profile based on the received input data. The first user profile may be specific to the first user 216 and may aggregate the set of accessibility preferences associated with the first user 216. Additionally, the first user profile may aggregate behavioral patterns, and individual needs into a comprehensive profile. Further, the first user profile may include attributes such as communication preferences, interaction modalities (e.g., touch, voice, gesture, and assistive technologies), and the like. In an embodiment, the input data may be manually entered by the first user 216 through the first user device 208. For example, the first user 216 may enter the input data by means of a chatbot, registration form, or a questionnaire where the first user 216 manually inputs the set of accessibility preferences. Additionally, the system 202 may be further configured to access external data sources associated with the first user 216 upon receiving permission and consent from the first user 216. In an embodiment, the external data sources may correspond to medical records associated with the first user 216 and stored on third party databases associated with the first user 216.

At 304, a profile linking operation may be executed. In the profile linking operation, the system 202 may be further configured to link the first user profile of the first user 216 with the set of customer profiles of the first user 216. In an embodiment, the set of customer profiles may be associated with the set of merchant entities 204. For example, a first customer profile of the set of customer profiles may correspond to a user account of the first user 216 for the first merchant entity 204A such that the first customer profile may include preferences (e.g., food preferences, service preference, and the like) and purchase history of the first user 216 with the first merchant entity 204A. The set of merchant entities 204 may correspond to one or more distinct merchant entities, each representing individual businesses or organizations. In an embodiment, the linking operation may be executed based on a confirmation from the first user 216. Further, the first user 216 may allow the first user profile to be linked with one or more customer profiles of the set of customer profiles based on selection of the one or more customer profiles. For example, the first user 216 may prefer to link the first user profile with five customer profiles from the set of customer profiles that includes ten customer profiles.

In an embodiment, the linking of the first user profile with the one or more customer profiles may require identification of the first user 216 through secure authentication methods, such as credentials or tokens. Based on the identification of the first user 216, the linking of the first user profile with the one or more customer profiles may be based on the utilization of application programming interfaces (APIs) provided by the set of merchant entities 204. The APIs may facilitate secure communication and data synchronization between the system 202 and the set of merchant entities 204 to ensure any updates in the first user profile are updated for each customer profile of the set of customer profiles. Details about the APIs to facilitate secure communication and data synchronization between the system 202 and the set of merchant entities 204 are already known in the art and have not been added for the sake of brevity.

In an embodiment, the input data of the first user 216 may be stored in the first user profile to ensure data security. Additionally, the server 214 may be associated with the first user profile and may include authentication mechanisms to verify the identities of the set of customer profiles such that only authorized access is allowed. Further, data transfer may occur through encrypted channels to maintain confidentiality and integrity during transmission, thus safeguarding the privacy of the first user 216 while allowing required access.

At 306, an engagement detection operation may be executed. In the engagement detection operation, the system 202 may be further configured to detect the first engagement between the first user 216 and the first interactor associated with the first merchant entity 204A. In an embodiment, the system 202 may be further configured to receive the first location data indicative of the first location of the first user device 208. Alternatively, the system 202 may receive the first location data indicative of the first location of a membership card associated with the first user 216. The system 202 may receive the first location data from at least one of the first user device 208 or the membership card associated with the first user 216 based on Global Positioning System (GPS) information, cellular network triangulation data, Wi-Fi positioning data, and the like. Further, the system 202 may be configured to receive the second location data indicative of the second location of the first interactor. The system 202 may receive the second location data from one or more geographic databases (e.g., the one or more databases 212). The system 202 may be further configured to determine that the first location is within the threshold distance of the second location to detect the first engagement between the first user 216 and the first interactor. For example, the threshold distance may be configured as five meters such that when the first location is detected within five meters of the second location, the first engagement may be detected.

In an alternate embodiment, the system 202 may be further configured to determine usage of one or more credentials associated with the first user 216 in at least one of a brick-and-mortar store or an application associated with the first merchant entity 204A to detect the first engagement between the first user 216 and the first interactor based on the determination of the usage of the one or more credentials. In an embodiment, the one or more credentials may correspond to various types of identification or access tokens, including membership cards, digital identifications (IDs), or unique access codes. The one or more credentials may be utilized to authenticate the first user 216, thereby facilitating secure transactions and interactions with the first merchant entity 204A. For example, the first engagement may be detected when a membership card associated with the first user 216 may be scanned at an access gate of the first merchant entity 204A. Further, the first engagement may be detected when the first user 216 may enter credentials to log into an application associated with the first merchant entity 204A. Additionally, the first merchant entity 204A may have cameras installed at various locations such that the first engagement may be detected when the first merchant entity 204A detects the presence of the first user 216 based on facial recognition.

Although it is mentioned that the system 202 may be configured to detect the first engagement between the first user 216 and the first interactor, in various embodiments, the first interactor may detect the first engagement with the first user 216 based on detecting that the first user device 208 is within the threshold distance. The first interactor may detect the first user device 208 based on various wireless communication technologies such as ultra-wideband (UWB), Bluetooth, Wi-Fi, Zigbee, near-field communication (NFC), and the like. For example, when the wireless communication technologies correspond to the UWB, the first interactor (e.g., the first merchant device 206A) may detect that the first user device 208 is within the threshold distance based on measuring time taken for a signal to travel between the first interactor and the first user device 208. Additionally, when the wireless communication technologies correspond to the NFC, the first interactor may detect the first engagement when the first user device 208 or a smart card associated with the first user 216 is tapped against the first interactor that may be NFC enabled.

Alternatively, the first interactor may detect the first engagement with the first user 216 based on usage of the one or more credentials associated with the first user 216 in at least one of a brick-and-mortar store or the application associated with the first merchant entity 204A. For example, the first user 216 may scan a smart card associated with the first user 216 such that the first interactor (e.g., the first merchant device 206A) may receive a unique identifier of the smart card associated with the first user 216, thereby detecting the first engagement. Upon detecting the first engagement, the first interactor may communicate with the system 202 via the server 214. Further, the server 214 may generate the first set of instructions associated with the first user 216. The server 214 may further provide the first set of instructions to the first interactor. In an embodiment, the first interactor may initiate API calls to retrieve the first set of instructions from the server 214.

At 308, it may be determined whether the first interactor is an automated system or not. In an embodiment, the first interactor may correspond to one of the automated system or the operator. The system 202 may be further configured to determine whether the first interactor is the automated system or not. In an embodiment, the first interactor may correspond to the automated system, such as a self-service kiosk or a similar system to facilitate the interactions (e.g., transactions) without direct human intervention. In an alternate embodiment, the first interactor may not correspond to the automated system. In such scenario, the first interactor may correspond to the operator, such as a cashier or an individual responsible for managing customer interactions and processing transactions.

In an embodiment, the system 202 may determine whether the first interactor is the automated system or not based on the first merchant data. For example, the system 202 may determine that the first interactor is the automated system when the first merchant data may indicate that the first merchant entity 204A (e.g., a brick and mortar store of the first merchant entity 204A) may include multiple automated systems and no operators. Alternatively, the system 202 may determine that the first interactor is not the automated system when the first merchant data may indicate that the first merchant entity 204A may include multiple operators and no automated systems.

In various embodiments, the system 202 may determine whether the first interactor is the automated system or not based on the distance between the first user 216 and the first interactor. For example, when the distance between the first user 216 and the automated system is within the threshold distance, the system 202 may classify the first interactor as the automated system. In case the first interactor is the automated system, then the control may be transferred to 310. Alternatively, in case the first interactor is not the automated system, then the control may be transferred to 312.

At 310, an accessibility feature activation operation may be executed. Upon the identification that the first interactor corresponds to the automated system, the system 202 may be further configured to generate the first set of instructions based on the application of the first ML model 210A on the input data and the first merchant data. Additionally, the system 202 may be further configured to control an interface of the first automated system based on the first set of instructions. The interface may be controlled to customize the first interaction (e.g., a transaction between the first user 216 and the automated system). In alternate words, the system 202 may be further configured to activate accessibility features associated with the first automated system based on the first set of instructions. By way of example and not by limitation, the activation of the accessibility features of the first automated system may correspond to increasing the font size of text displayed on the interface to improve the readability of the first user 216, when the set of accessibility preferences of the first user 216 corresponds to larger text due to visual impairments. Based on the activation of the accessibility features, the first automated system may dynamically adjust display settings based on the accessibility preferences of the first user 216. Alternatively, the activation of the accessibility features of the first automated system may further correspond to updating color combinations or adjusting contrast between text and background colors to accommodate the first user 216 with color blindness or light sensitivity, text-to-speech functionality to enable audio output to accommodate the first user 216 with reading difficulties or visual impairments, and the like.

At 312, an operator recommendation generation operation may be executed. In an embodiment, the system 202 may be further configured to generate the first set of instructions based on the application of the first ML model 210A on the input data and the first merchant data. The first set of instructions may be generated based on the determination that the first interactor is not the automated system. Thus, the first interactor may correspond to the operator. Additionally, the system 202 may be further configured to render the set of recommendations to the operator. The set of recommendations may be rendered based on the first set of instructions to customize the first interaction (e.g., a transaction between the first user 216 and the operator). Examples of the set of recommendations are provided, for example, in FIG. 5. Thus, by the accessibility feature activation operation and the operator recommendation generation operation, the system 202 ensures that the first interactor (the automated system or the operator) receives actionable, and data driven instructions (e.g., the first set of instructions) to render personalized adjustments to interactors (e.g., the first interactor) for the set of users with diverse accessibility preferences. Thus, the system 202 improves accessibility and communication during the interaction process, ensuring that the users with diverse accessibility needs can engage more effectively with one or more merchant entities of the set of merchant entities.

At 314, a data collection operation may be executed. In the data collection operation, the system 202 may be further configured to receive the first feedback generated based on the first interaction from the first user 216. In an embodiment, the first feedback may correspond to the satisfaction of the first user 216 based on the first interaction. the first feedback may correspond to one of positive interaction and negative interaction between the first user 216 and the first interactor such that the first feedback may include metrics such as the time of day and day of the week. By way of example and not by limitation, the first feedback may include that the first user 216 requires the customization of the interaction (e.g., the first interaction) during nighttime and not during daylight.

In an embodiment, when the first interaction between the first user 216 and the automated system is completed, the first feedback may include data reflecting effectiveness of the accessibility feature activation operation for the first user 216. For example, the first feedback may include speed of task completion (e.g., the interaction), or frequency of errors encountered during the first interaction. Alternatively, when the first interaction was between the first user 216 and the operator, the first feedback may include data reflecting effectiveness of the operator recommendation generation operation for the first user 216. For example, the first feedback may include time taken by operator to assist the first user 216, or satisfaction rating provided by the first user 216 regarding the assistance received by the operator. Thus, the system 202 may then utilize the first feedback to train the first ML model 210A on the first feedback and the first set of instructions. Further, the trained first ML model 210A may generate the second set of instructions to customize the second interaction between the first user 216 and at least one merchant entity of the set of merchant entities 204 such that the second interaction between the first user 216 and at least one merchant entity may be customized when the second interaction is during nighttime. The system 202 improves the first ML model 210A based on the first feedback, thus the system 202 may enhance the ability of the first ML model 210A to generate accurate and context-aware instructions (e.g., the second set of instructions) for customizing user interactions. Further, the system 202 may adapt to changing conditions such as time of the day to provide tailored set of instructions for different scenarios (e.g., nighttime) to better assist the users with an improved set of instructions for customizing the interactions.

In an additional embodiment, when the first interaction is between the first user 216 and the first interactor, the first feedback may correspond to specific instructions related to the first merchant entity 204A. For example, when the first user 216 encounters multiple card failure issues during the first interaction (e.g., transaction) at the first merchant entity 204A, the first feedback may correspond to a reminder to utilize an alternate payment method for any further interactions with the first merchant entity 204A. Based on the first feedback, the system 202 may notify the first user 216 to utilize any alternate payment method for further interactions with the first merchant entity 204A.

Although it is mentioned that the system 202 may receive the first feedback from the first user 216, in various embodiments, the first electronic device associated with the first merchant entity 204A may receive the first feedback from the first user 216. Further, based on the first feedback, the first merchant entity 204A may improve upcoming interactions with the first user. In an embodiment, the first electronic device may be positioned at an exit gate of the first merchant entity 204A such that the first feedback may be anonymous to protect the privacy of the users (e.g., the first user 216), thereby facilitating trust and encouraging open feedback without compromising user confidentiality.

At 316, a report generation operation may be executed. In the report generation operation, the system 202 may be further configured to generate the interaction report based on the first feedback. The system 202 may be further configured to transmit the interaction report to the first electronic device associated with the first merchant entity 204A. In an embodiment, the interaction report may include at least one of a rating associated with interaction (e.g., at least one of the first interaction, the second interaction, or the third interaction), duration of the interaction, one or more suggestions for improvement of the upcoming interactions, and one or more special requests associated with at least one user of the set of users. Examples of special requests may include preferred communication style, language preference, and the like.

In additional embodiments, the interaction report may correspond to an anonymized report. The anonymized report may correspond to a report that excludes personalized data associated with the first user 216, thereby keeping the first feedback anonymous. Exemplary contents of the anonymized report may include the duration of the first interaction, location of the first interaction, time of the first interaction, and tone, sentiments, or ratings associated with the first interaction.

Additionally, the interaction report may include a set of targeted suggestions and recommendations tailored for the set of merchant entities 204. Based on the interaction report, the set of merchant entities 204 may identify specific areas for improvement such as short interaction duration or negative feedback and resolve them based on the set of targeted suggestions and recommendations. Thus, the system 202 may improve user satisfaction and interactions based on the feedback (e.g., the first feedback) for each merchant entity of the set of merchant entities 204. For example, when the anonymized report may indicate a short interaction duration, the recommendation may include the implementation of interactive elements, such as customer surveys or personalized follow-ups, to foster deeper engagement. Additionally, when the anonymized report may include negative feedback, the recommendation may highlight specific areas for improvement, such as staff training on customer service or adjustments to product offerings to better align with user preferences. Thus, the system 202 provides suggestions and recommendations to the set of merchant entities 204 while protecting the privacy of the users (e.g., the first user 216), thereby facilitating trust and encouraging open feedback without compromising user confidentiality.

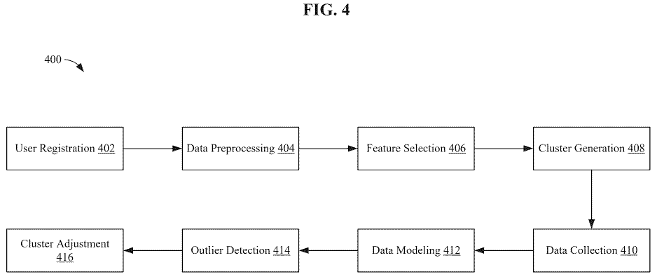

FIG. 4 is a diagram that illustrates exemplary operations for generating one or more clusters of the set of users, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 416, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a user registration operation may be executed. In the user registration operation, a set of user devices associated with the set of users may receive input from respective users. The input received from the set of users may be hereinafter referred to as “historical input data”. The historical input data may include the plurality of accessibility preferences associated with the set of users. In an embodiment, the set of users may correspond to the PwD such that the plurality of accessibility preferences may correspond to a range of personalized requirements suitable for the set of users. In additional embodiments, the set of users may not correspond to the PwD, however, the set of users may have the plurality of accessibility preferences to improve or customize interactions with one or more interactors associated with the set of merchant entities 204.

The system 202 may be configured to receive the historical input data including the plurality of accessibility preferences associated with the set of users. The system 202 may be further configured to generate a set of user profiles (e.g., the first user profile for the first user 216) specific to the set of users based on the historical input data. Details about the generation of the first user profile are provided, for example, in FIG. 2, and FIG. 3 and are applicable to the set of user profiles.

At 404, a data preprocessing operation may be executed. In the cluster generation operation, the system 202 may be further configured to clean the historical input data by removing duplicate entries, correcting typographical errors, and addressing missing values through various statistical imputation techniques such as mean imputation, mode imputation, K-nearest neighbors (KNN) imputation, and the like. Additionally, the system 202 may implement normalization procedures to standardize the historical input data, thereby ensuring that all features associated with the historical input data are evaluated comparably. By way of example and not by limitation, the system 202 may implement min-max scaling or z-score normalization to mitigate potential biases for the features associated with the historical input data. Details about the cleaning of the historical input data and implementation of the normalization procedures to standardize the historical input data are already known in the art and have not been added for the sake of brevity.

At 406, a feature selection operation may be executed. In the feature selection operation, the system 202 may be further configured to apply the second ML model 210B on the historical input data to identify relevant features or attributes associated with the historical input data. By way of example and not by limitation, the system 202 may identify various user characteristics, such as age, gender, type of disability, and technological proficiency for the generation of clusters. In an embodiment, the second ML model 210B may utilize statistical techniques, such as correlation analysis and information gain calculations, to determine features that may significantly influence clustering outcomes. Details about various techniques for the feature selection are already known in the art and have not been added for the sake of brevity.

At 408, a cluster generation operation may be executed. In the cluster generation operation, the system 202 may be further configured to generate the one or more clusters from the set of users based on the application of the second ML model 210B on the historical input data. In an embodiment, the system 202 may generate the one or more clusters based on the identified features or attributes associated with the historical input data that includes the plurality of accessibility preferences associated with the set of users. Further, the one or more clusters may be generated to facilitate data-driven decision-making, personalization of service, and iterative improvement based on feedback. For example, the one or more clusters may serve as a basis for gathering feedback on specific features or interventions. Further, based on the generation of the one or more clusters, the system 202 may determine how different clusters respond to different situations iteratively. Thus, the system 202 may generate targeted personalization for each user of each cluster that may be more efficient and precise.

In an embodiment, the system 202 may generate the one or more clusters based on age demographics such that one or more users of the set of users aged 50 to 60 may form a first cluster, while one or more users of the set of users aged 60 to 70 may form a second cluster. Thus, the system 202 may recognize patterns and preferences associated with different age groups regarding different accessibility requirements and technological proficiencies. For example, the system 202 may determine that the older users (e.g., aged 60 and above) may prefer simplified interfaces featuring larger text and voice command capabilities. Additionally, the system 202 may determine that the one or more users aged 50 to 60 may prefer text size in the range of medium to large while the one or more users aged 60 to 70 may prefer text size in the range of large to extra-large.

In additional embodiments, the system 202 may generate the one or more clusters based on types of disabilities, such that one or more users of the set of users with visual impairments may form a third cluster, while one or more users of the set of users with hearing impairments may form a fourth cluster. This differentiation enables the development of specialized tools tailored to each cluster such that the one or more users with visual impairments might require screen readers and audio descriptions, while those with hearing impairments could activate captioning services or sign language interpretation.

In additional embodiments, the system 202 may generate the one or more clusters based on behavioral data such that one or more users of the set of users who predominantly utilize voice-activated features may form a fifth cluster, while one or more users of the set of users relying more on manual inputs may form a sixth cluster. The system 202 may analyze user interaction patterns to facilitate the refinement of existing accessibility features, allowing for enhancements that align with user habits. For example, when a significant number of users demonstrates a preference for voice commands, the system 202 may prioritize improvements in voice recognition accuracy or the introduction of new voice-controlled functionalities by providing feedback to different interactors associated with the set of merchant entities 204.

At 410, a data collection operation may be executed. In the data collection operation, the system 202 may be further configured to receive feedback data (e.g., the first feedback) generated based on interactions between the set of users and a set of interactors associated with the set of merchant entities 204. Each interactor of the set of interactors may correspond to one of the operator or the automated system (e.g., the kiosk). In an embodiment, the system 202 generates the one or more clusters for the set of users during the cluster generation operation. Further, the interactions of the set of users may be tailored based on the one or more clusters such that the feedback may correspond to the satisfaction of the set of users based on the interactions between the set of users and the set of interactors. Details about the reception of the feedback data (e.g., the first feedback) are provided, for example, in FIG. 2, and FIG. 3 and are applicable for the set of users.

At 412, a data modeling operation may be executed. In the data modeling operation, the system 202 may be further configured to analyze the received feedback data to model the interactions and preferences of the set of users. In an embodiment, the system 202 may use analytical techniques, such as regression analysis, correlation analysis, and the like to identify relationships between the one or more clusters and user satisfaction. For example, the system 202 may determine that younger users prefer advanced interfaces with medium font size, while older users prefer simpler interfaces with larger font size. The system 202 may be further configured to receive interaction data associated with the set of users. In an embodiment, the interaction data associated with the set of users may correspond to regular activity patterns, including metrics such as frequency, duration, time of day, and day of the week to visit at least one merchant entity of the set of merchant entities 204. The interaction data may be incorporated into the second ML model 210B (e.g., a supervised ML model). In an embodiment, the second ML model 210B may correspond to a Naive Bayes model. The system 202 may apply the Bayes theorem under the assumption of conditional independence between each pair of features associated with the interaction data, given the value of the class variable. For example, in a retail context, the class variable could represent the categories associated with the interaction data, such as high interaction or low interaction. The second ML model 210B may analyze a relation between various features such as the time of day, frequency of visits, and duration of each visit may relate to the categories of the interaction data. By analyzing such relationships, the system 202 may predict future user behavior and optimize interactions, thereby improving user experience. In an embodiment, the system 202 may further train the first ML model 210A based on the analysis of the relation between various features. For example, when the system 202 may analyze that the first user 216 frequently interacts with the first merchant entity 204A during lunch hours, the system 202 may render time-sensitive promotions such as lunch time discounts on the automated system or instruct the operator to convey the lunch time discounts to the first user 216, thereby optimizing the upcoming interactions between the first user 216 and the first merchant entity 204A.

In an embodiment, the system 202 may be further configured to detect the third engagement between the second user and the first interactor. The second user may correspond to a user without any set of accessibility preferences. The second user may provide one or more features (e.g., age, gender, ethnicity, and the like) to the system 202. Alternatively, the first interactor may determine the one or more features associated with the second user based on at least one of speech detection, facial recognition, and the like when the second user is within the threshold distance of the first interactor. Further, the system 202 may be configured to identify that the second user is associated with a first cluster of the one or more clusters based on mapping the one or more features with the features associated with the one or more clusters. By way of example and not by limitation, the first cluster may correspond to a subset of users aged between 60 years to 70 years with poor vision such that the subset of users may require a larger font size while interacting with the first interactor. The system 202 may be further configured to generate the third set of instructions based on the identification that the second user is associated with the first cluster and may require a larger font size. Additionally, the system 202 may be configured to render the third set of instructions to the first merchant entity 204A to customize the third interaction between the second user and the first interactor.

The system 202 may be further configured to analyze a set of historical interactions associated with the first cluster of users upon the detection of the third engagement. The system 202 may be further configured to generate the set of suggestions for the second user based on the analysis of the interaction histories. The system 202 may be further configured to render the set of suggestions to a second user device associated with the second user. The set of suggestions includes at least one of product suggestions, preferred service options, promotions, or optimal duration for interactions.

In an embodiment, the generated set of suggestions may include feature preferences associated with one or more users associated with the first cluster based on the time of day. For example, when the set of historical interactions indicates that the set of users in the first cluster typically enable backlit buttons when interacting with the automated system during late hours, the system 202 may suggest the second user to activate a backlit option to enhance the overall experience.

In additional embodiments, the generated set of suggestions may include contextual suggestions based on a series of actions performed by one or more users associated with the first cluster. For example, when the set of historical interactions indicates that most users in the first cluster tend to complete task A before moving on to task B, the system 202 may recommend that the second user complete task A first to streamline workflow and align with common user behavior. In further embodiments, the system 202 may generate a set of suggestions based on frequency of actions, speed of actions, repetition of actions, and the like.

In various embodiments, the generated set of suggestions may include the optimal duration for interactions. The optimal duration may refer to the ideal amount of time recommended for users to complete their interactions with the automated system, based on data associated with the set of historical interactions and user behavior patterns. For example, when the set of historical interactions indicates that the set of users in the first cluster typically takes about five minutes to complete the interactions with the automated system, the system 202 may recommend the second user to complete the interactions to avoid congestion. Alternatively, the system 202 may recommend alternate time slots to the second user to visit the first merchant entity 204A.

At 414, an outlier detection operation may be executed. In the outlier detection operation, the system 202 may be further configured to identify anomalies or outliers (e.g., one or more users of the set of users) from the set of users that may deviate significantly from established patterns or expected behaviors based on the analysis of the set of historical interactions. In an embodiment, the system 202 may identify the anomalies or the outliers from the set of users based on the analysis of the relation between various features associated with the interaction data (e.g., the time of day, frequency of visits, and duration of each visit) for the set of users in the data modeling operation . The system 202 may be further configured to apply the first ML model 210A on the set of historical interactions. In an embodiment, the system 202 may evaluate various parameters, such as engagement frequency, interaction duration, and the sequence of actions taken by the set of users to establish a baseline of typical user behavior within each cluster of the one or more clusters. Thus, the system 202 may identify the outliers having different behavior from the expected behavior. For example, when a user of the set of users typically engages with a feature of the automated system at a consistent frequency but suddenly shows a drastic increase or decrease in usage, the system 202 may flag this deviation as an outlier. Similarly, when the user completes tasks in an unexpected order or exhibits unusually fast or slow interaction speeds, the system 202 may flag this deviation as an outlier. Thus, the system 202 further improves the first ML model 210A based on the identified outlier to assist the users with an improved set of instructions for customizing the interactions.

At 416, a cluster adjustment operation may be executed. In the cluster adjustment operation, the system 202 may be further configured to update the one or more clusters based on at least one of the received feedback data and the identified anomalies or outliers. By way of example and not by limitation, a set of users associated with the second cluster that may correspond to users with mobility impairments, may be increasingly utilizing voice-activated controls. The system 202 may be further configured to monitor the shift in preferences of the set of users associated with the second cluster based on the feedback data. Further, the system 202 may be configured to generate an additional cluster to accommodate the set of users associated with the second cluster that may prefer voice-activated controls. Thus, by continuously updating the one or more clusters, the system 202 may ensure that the one or more clusters are dynamic and responsive to the evolving needs of the set of users, thereby enhancing the effectiveness of customization for the upcoming interactions.

FIG. 5A is a diagram that illustrates an exemplary first user interface (UI) for interaction at a first time instance T1, in accordance with an embodiment of the disclosure. FIG. 5A is explained in conjunction with elements from FIG. 1, FIG. 2, FIG. 3, and FIG. 4. With reference to FIG. 5A, there is shown an exemplary menu page 500 of an automated system (e.g., the first interactor) associated with the first merchant entity 204A. The exemplary menu page 500 may include a first plurality of UI elements. The first plurality of UI elements may include a first UI element 502, a second UI element 504, a third UI element 506, a fourth UI element 508, a fifth UI element 510, and a sixth UI element 512. Each UI element of the first plurality of UI elements may correspond to a button and may include an image representing different selectable options.

In an embodiment, the exemplary menu page 500 may correspond to a screen at a food outlet kiosk where the user may select various food items. Further, the first UI element 502, the second UI element 504, the third UI element 506, the fourth UI element 508, the fifth UI element 510, and the sixth UI element 512 may correspond to selectable UI elements each representing a specific food item available for purchase at the first merchant entity 204A. Further, each selectable UI element may also be accompanied by an icon or image representing the product, such as a picture of the respective food item, offering a visual representation of the item for the user to facilitate faster identification of the product. For example, the first UI element 502 may represent a sandwich, the second UI element 504 may represent a pizza, the third UI element 506 may represent a burger, the fourth UI element 508 may represent a beverage, the fifth UI element 510 may represent French fries, and the sixth UI element 512 may represent an ice cream. The exemplary menu page 500 further includes one or more fields that may be used to display quantity and price as the total amount of the selected UI elements from the first UI element 502, the second UI element 504, the third UI element 506, the fourth UI element 508, the fifth UI element 510, and the sixth UI element 512.

In an embodiment, the first time instance T1 may correspond to a time period before the rendering of the first set of instructions to the automated system associated with the first merchant entity 204A by the system 202. In additional embodiments, the first time instance T1 may correspond to a time period prior to the detection of the first engagement between the first user 216 and the automated system. Prior to the rendering of the first set of instructions, a font associated with text on the exemplary menu page 500 and a size associated with images on each of the first UI element 502, the second UI element 504, the third UI element 506, the fourth UI element 508, the fifth UI element 510, and the sixth UI element 512 may be set to medium size such that the text and the images may be visible to most of the users of the set of users (e.g., users without visual impairments).

FIG. 5B is a diagram that illustrates an exemplary UI for interaction at a second time instance T2, in accordance with an embodiment of the disclosure. FIG. 5B is explained in conjunction with elements from FIG. 1, FIG. 2, FIG. 3, FIG. 4, and FIG. 5A. With reference to FIG. 5B, there is shown an exemplary customized menu page 514 on the automated system (e.g., the first interactor) associated with the first merchant entity 204A. The exemplary customized menu page 514 may include a second plurality of UI elements. In an embodiment, the second plurality of UI elements may correspond to an enlarged version of the first plurality of UI elements. The second plurality of UI elements may include a customized first UI element 516, a customized second UI element 518, a customized third UI element 520, a customized fourth UI element 522, a customized fifth UI element 524, and a customized sixth UI element 526. Each UI element of the second plurality of UI elements may correspond to a button and may include the image representing the different selectable options.

During the time instance T1 and the time instance T2, the system 202 may be further configured to detect the first engagement between the first user 216 and the first interactor (e.g., the automated system). Details about the detection of the first engagement are provided, for example, in FIG. 2 and FIG. 3. Further, the system 202 may generate the first set of instructions for customization of the first interaction between the first user 216 and the first interactor by the first interactor. The first interaction may be customized based on the set of accessibility preferences associated with the first user 216. In an embodiment, the first user 216 may have poor vision such that the set of accessibility preferences associated with the first user 216 may correspond to large text and images.

The second time instance T2 may correspond to a time period after the system 202 renders the first set of instructions to the first interactor to customize the first interaction between the first user 216 and the automated system associated with the first merchant entity 204A. In additional embodiments, the second time instance T2 may correspond to a time period after detection of the first engagement between the first user 216 and the automated system. After the rendering of the first set of instructions, a font associated with text on the exemplary customized menu page 514 and a size associated with images on each of the customized first UI element 516, the customized second UI element 518, the customized third UI element 520, the customized fourth UI element 522, the customized fifth UI element 524, and the customized sixth UI element 526 may be set to large size such that the text and the images may be visible to most of the users of the set of users with poor vision.

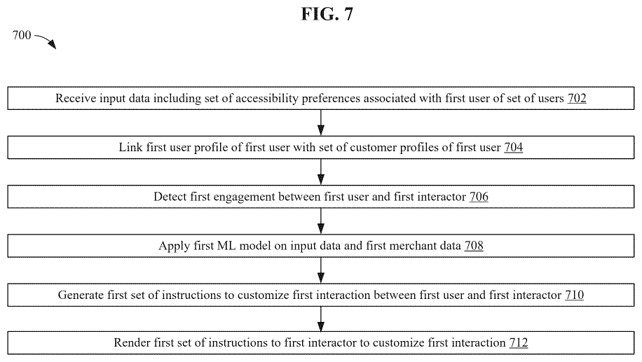

FIG. 6 is a diagram that illustrates an exemplary UI for interaction with recommendations, in accordance with an embodiment of the disclosure. FIG. 6 is explained in conjunction with elements from FIG. 1, FIG. 2, FIG. 3, FIG. 4, FIG. 5A, and FIG. 5B. With reference to FIG. 6, there is shown an exemplary diagram 600 that includes an exemplary checkout page 602 when the first interactor may correspond to an operator. The checkout page 602 may include a summary of an ongoing interaction (e.g., transaction) of the first user 216. The checkout page 602 may include a set of items selected by the first user 216 to be purchased. The checkout page 602 displays a table summarizing the set of items and their respective amount.

In an embodiment, the system 202 may be configured to detect the first engagement between the first user 216 and the first interactor (e.g., the operator). Details about the detection of the first engagement are provided, for example, in FIG. 2 and FIG. 3. Further, the system 202 may generate the first set of instructions for customization of the first interaction between the first user 216 and the first interactor by the first interactor. The first interaction may be customized based on the set of accessibility preferences associated with the first user 216. In an embodiment, the first user 216 may have hearing impairment such that the set of accessibility preferences associated with the first user 216 may correspond to loud and clear speech.

The set of items on the checkout page 602 may be the food items being purchased by the first user 216 in a merchant store associated with the first merchant entity 204A such that a total of four items are billed. For the sake of brevity, the four items are labeled as “Ice cream”, “Sandwich”, “Burger”, and “Pizza”. Further, the cost associated with the Ice cream, the Sandwich, the Burger, and the Pizza may be $2.50, $3.00, $5.00, and $9.95, respectively, such that a total amount may be $20.45.

The system 202 may be configured to render the set of recommendations to a device (e.g., a checkout device) associated with the operator. Based on the set of recommendations, the checkout page 602 may modify an instruction UI element 604. In an embodiment, the instruction UI element 604 may be labeled as “special instruction” and may contain a recommendation message for the operator (e.g., the customer service representatives) to assist the first user 216 during the first interaction.

In an embodiment, the first user 216 may be identified as “Mr. Paul”, who may have a hearing disability. As illustrated in FIG. 6, the instruction UI element 604 on the checkout page 602 may display a prompt stating, “Please read the final amount aloud and clearly for Mr. Paul”. This instruction suggests the operator to communicate the final amount in a loud and clear manner, thereby customizing the interaction based on the accessibility preferences of the first user 216. Thus, the operator may communicate the final bill as $20.45 for Mr. Paul. In various embodiments, the instruction UI element 604 may display different prompts tailored to the accessibility preferences of the set of users, ensuring that the interaction process is inclusive and accommodates the specific needs of individuals with diverse disabilities.

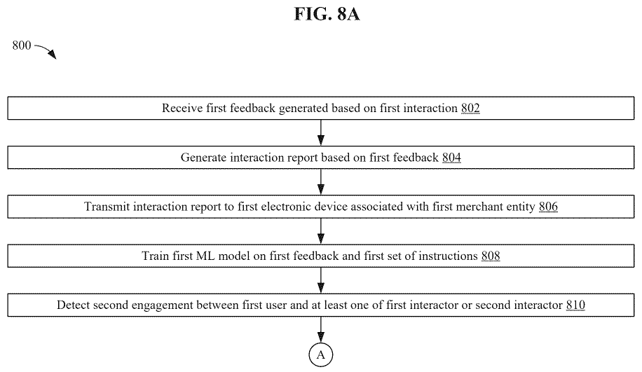

FIG. 7 is a diagram that illustrates a flowchart of an exemplary method for interaction customization based on user accessibility needs, in accordance with an embodiment of the disclosure. FIG. 7 is explained in conjunction with elements from FIG. 1, FIG. 2, FIG. 3, FIG. 4, FIG. 5A, FIG. 5B, and FIG. 6. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, the first input including the set of accessibility preferences associated with the first user 216 of the set of users may be received. In an embodiment of the disclosure, the system 202 may be configured to receive the first input. The set of accessibility preferences may correspond to a plurality of accessibility needs of the first user 216 and may be collected through a smartphone (e.g., the first user device 208), chatbot, or manual selection based on the choice of the first user 216. Details about the reception of the first input are provided, for example, in FIG. 2, and FIG. 3.

At 704, the first user profile may be linked with the set of customer profiles of the first user 216. In an embodiment of the disclosure, the system 202 may be configured to link the first user profile with the set of customer profiles of the first user 216. The set of customer profiles may be associated with the set of merchant entities 204. Details about the linking of the first user profile with the set of customer profiles are provided, for example, in FIG. 2, and FIG. 3.

At 706, the first engagement between the first user 216 and the first interactor may be detected. In an embodiment of the disclosure, the system 202 may be configured to detect the first engagement between the first user 216 and the first interactor. The first interactor may be associated with the first merchant entity 204A of the set of merchant entities 204 based on the linking of the user profile and the set of customer profiles. The first engagement may be detected based on the linking of the first user profile and the set of customer profiles. In an embodiment, the first engagement may correspond to the first location of the first user device 208 associated with the first user 216 being within the threshold distance of the second location of the first interactor. In additional embodiments, the first engagement may correspond to the determination of usage of the one or more credentials associated with the first user 216 in at least one of the brick-and-mortar stores or the application associated with the first merchant entity 204A. Details about the detection of the first engagement are provided, for example, in FIG. 2, and FIG. 3.

At 708, the first ML model 210A may be applied to the input data and the first merchant data. In an embodiment of the disclosure, the system 202 may be configured to apply the first ML model 210A on the input data and the first merchant data. The first merchant data may be associated with the first merchant entity 204A and may correspond to information associated with the first interactor. In an embodiment of the disclosure, the system 202 may be configured to apply the first ML model 210A on the input data and the first merchant data. Details about the application of the first ML model 210A on the input data and the first merchant data are provided, for example, in FIG. 2, and FIG. 3.

At 710, the first set of instructions may be generated to customize the first interaction between the first user 216 and the first interactor. In an embodiment of the disclosure, the system 202 may be configured to generate the first set of instructions based on the application of the first ML model 210A on the input data and the first merchant data. The first set of instructions may be generated for customization of the first interaction. Details about the generation of the first set of instructions are provided, for example, in FIG. 2, and FIG. 3.

At 712, to customize the first interaction, the first set of instructions may be rendered to the first interactor. In an embodiment of the disclosure, the system 202 may be configured to render the first set of instructions to the first interactor to customize the first interaction. Thus, the system 202 may ensure that the user experience of the first user 216 is personalized based on the input data. Details about the rendering of the first set of instructions are provided, for example, in FIG. 2, and FIG. 3.

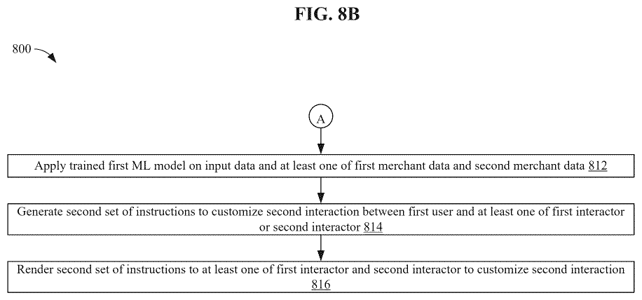

FIGS. 8A and 8B are diagrams that collectively illustrate a flowchart of an exemplary method for interaction customization based on feedback data, in accordance with an embodiment of the disclosure. FIG. 7 is explained in conjunction with elements from FIG. 1, FIG. 2, FIG. 3, FIG. 4, FIG. 5A, FIG. 5B, FIG. 6, and FIG. 7. With reference to FIGS. 8A and 8B, there is shown a flowchart 800. The operations of the exemplary method may be executed by any computing system, for example, by the computer 102 of FIG. 1 or the system 202 of FIG. 2. The operations of the flowchart may start at 802.

Referring now to FIG. 8A, at 802, the first feedback associated with the first interaction between the first user 216 and the first interactor may be received. In an embodiment of the disclosure, the system 202 may be configured to receive the first feedback. The first feedback may be generated by the first user 216. The first feedback may include qualitative and quantitative metrics based on user preferences, interaction patterns, and engagement level. In an additional embodiment, the first feedback may be derived from user behavioural data, system logs, or real-time feedback generated during the first interaction.

At 804, the interaction report may be generated based on the first feedback. In an embodiment of the disclosure, the system 202 may be further configured to generate the interaction report. The interaction report may correspond to the anonymized report that excludes personalized data associated with the first user 216, thereby keeping the first feedback anonymous. Exemplary contents of the anonymized report may include duration of the first interaction, location of the first interaction, time of the first interaction, and tone, sentiments, or ratings associated with the first interaction.

At 806, the interaction report may be transmitted to the first electronic device associated with the first merchant entity 204A. In an embodiment of the disclosure, the system 202 may be further configured to transmit the interaction report. The system 202 may transmit the interaction report based on the approval or consent of the first user 216. The interaction report may include at least one of the ratings associated with the first interaction, the duration of the first interaction, the one or more suggestions for improvement of the second interaction, and one or more special requests associated with the first user 216. The transmission of the interaction report may be through a secure communication channel that may include but not limited to encrypted connections such as Secure Sockets Layers (SSL), Transport Layer Security (TLS), or Virtual Private Networks (VPNs). The use of encryption may ensure the integrity and/or confidentiality of the transmitted data (e.g., the first feedback) and may prevent unauthorized access during the transmission.

At 808, the first ML model 210A may be trained on the first feedback and the first set of instructions. In an embodiment of the disclosure, the system 202 may be configured to train the first ML model 210A. During the training of the first ML model 210A, one or more parameters of each node of the first ML model 210A may be updated based on whether an output of the final layer for a given input (from the training dataset) matches a correct result based on a loss function for the first ML model 210A. The above process may be repeated for the same or a different input until a minimum of loss function may be achieved, and a training error may be minimized. In additional embodiments, the system 202 may train the first ML model 210A on additional feedback received from the set of users.

At 810, the second engagement may be detected between the first user 216 and at least one of the first interactor or the second interactor. In an embodiment of the disclosure, the system 202 may be further configured to detect the second engagement between the first user 216 and at least one of the first interactor or the second interactor. The system 202 may determine that the first location is within the threshold distance of at least one of the second location of the first interactor or the third location of the second interactor. Further, the system 202 may detect the second engagement based on the determination that the first location is within the threshold distance of the at least one of the second location or the third location. In additional embodiments, the system 202 may determine usage of the one or more credentials associated with the first user 216 in at least one of a brick-and-mortar store associated with the first merchant entity 204A, or the application associated with the first merchant entity 204A. Further, the system 202 may detect the second engagement based on the determination of the usage of the one or more credentials.

Referring now to FIG. 8B, at 812, the trained first ML model 210A may be applied on the input data and at least one of the first merchant data and the second merchant data. In an embodiment of the disclosure, the system 202 may be configured to apply the trained first ML model 210A on the input data and at least one of the first merchant data and the second merchant data. The first merchant data may be associated with the first merchant entity 204A and may correspond to information associated with the first automated system (e.g., the first interactor) of the first merchant entity 204A. Similarly, the second merchant data may be associated with the second merchant entity 204B and may correspond to information associated with a second automated system (e.g., the second interactor) of the second merchant entity 204B. Details about the first merchant data and the second merchant data are provided, for example, in FIG. 2 and FIG. 3.

At 814, the second set of instructions is generated based on the training of the first ML model 210A on the first feedback and the first set of instructions. In an embodiment of the disclosure, the system 202 may be further configured to generate the second set of instructions. The second set of instructions may be generated based on at least one of the first merchant data and the second merchant data. Further, the second set of instructions may be generated to customize the second interaction between the first user 216 and at least one of the first interactor or the second interactor.

At 816, the second set of instructions may be rendered to at least one of the first interactor or the second interactor to customize the second interaction between the first user 216 and the at least one of the first interactor or the second interactor. In an embodiment of the disclosure, the system 202 may be further configured to render the second set of instructions. Details about the rendering of the second set of instructions are provided, for example, in FIG. 2 and FIG. 3.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
receiving, by a computer, input data comprising a set of accessibility preferences associated with a first user of a set of users;
linking, by the computer, a user profile of the first user with a set of customer profiles of the first user based on the input data, wherein the set of customer profiles is associated with a set of merchant entities;
detecting, by the computer, a first engagement between the first user and a first interactor, wherein the first interactor is associated with a first merchant entity of the set of merchant entities based on the linking of the user profile and the set of customer profiles;
applying, by the computer, a first machine learning (ML) model on the input data and first merchant data, wherein the first merchant data is associated with the first merchant entity;
generating, by the computer, a first set of instructions based on the application of the first ML model on the input data and the first merchant data, wherein the first set of instructions is generated for customization of a first interaction between the first user and the first interactor by the first interactor; and
rendering, by the computer, the first set of instructions to the first interactor for the customization of the first interaction.

2. The computer-implemented method of claim 1, further comprising:
receiving, by the computer, a first feedback based on the first interaction;
training, by the computer, the first ML model on the first feedback and the first set of instructions; and
generating, by the computer, a second set of instructions based on the training of the first ML model on the first feedback and the first set of instructions, wherein the second set of instructions is generated for customization of a second interaction between the first user and at least one of the first interactor or a second interactor by the at least one of the first interactor or the second interactor, wherein the second interactor is associated with a second merchant entity of the set of merchant entities.

3. The computer-implemented method of claim 2, further comprising:
detecting, by the computer, a second engagement between the first user and the at least one of the first interactor or the second interactor;
applying, by the computer, the trained first ML model on the input data and at least one of the first merchant data or second merchant data, wherein the second merchant data is associated with the second merchant entity;
generating, by the computer, the second set of instructions based on the application of the trained first ML model on the input data and the at least one of the first merchant data or the second merchant data; and
rendering, by the computer, the second set of instructions to the at least one of the first interactor or the second interactor for the customization of the second interaction.

4. The computer-implemented method of claim 2, further comprising:
generating, by the computer, an interaction report based on the first feedback; and
transmitting, by the computer, the interaction report to a first electronic device associated with the first merchant entity.

5. The computer-implemented method of claim 4, wherein the interaction report comprises at least one of a rating associated with the first interaction, a duration of the first interaction, one or more suggestions for improvement of the second interaction, or one or more special requests associated with the first user.

6. The computer-implemented method of claim 1, further comprising:
receiving, by the computer, first location data indicative of a first location of a first user device associated with the first user;
receiving, by the computer, second location data indicative of a second location of the first interactor;
determining, by computer, that the first location is within a threshold distance of the second location; and
detecting, by the computer, the first engagement between the first user and the first interactor based on the determination that the first location is within the threshold distance of the second location.

7. The computer-implemented method of claim 1, further comprising:
determining, by the computer, a usage of one or more credentials associated with the first user in at least one of a brick-and-mortar store associated with the first merchant entity, or an application associated with the first merchant entity; and
detecting, by the computer, the first engagement between the first user and the first interactor based on the determination of the usage of the one or more credentials.

8. The computer-implemented method of claim 1, further comprising:
determining, by the computer, that the first interactor corresponds to an automated system;
generating, by the computer, the first set of instructions based on the determination that the first interactor corresponds to the automated system; and
controlling, by the computer, an interface of the automated system based on the first set of instructions, wherein the interface is controlled for the customization of the first interaction.

9. The computer-implemented method of claim 1, further comprising:
determining, by the computer, that the first interactor corresponds to an operator;
generating, by the computer, the first set of instructions based on the determination that the first interactor corresponds to the operator; and
rendering, by the computer, a set of recommendations for the operator based on the first set of instructions.

10. The computer-implemented method of claim 1, further comprising:
applying, by the computer, a second ML model on historical input data comprising a plurality of accessibility preferences associated with the set of users; and
generating, by the computer, one or more clusters from the set of users based on the application of the second ML model on the historical input data.

11. The computer-implemented method of claim 10, further comprising:
detecting, by the computer, a third engagement between a second user and the first interactor, wherein the second user is different from the set of users;
identifying, by the computer, the second user is associated with a first cluster of the one or more clusters;
generating, by the computer, a third set of instructions based on the identification that the second user is associated with the first cluster, wherein the third set of instructions is generated for customization of a third interaction between the second user and the first interactor by the first interactor; and
rendering, by the computer, the third set of instructions to the first interactor for the customization of the third interaction.

12. The computer-implemented method of claim 11, further comprising:
analyzing, by the computer, a set of historical interactions associated with the first cluster of users based on the detection of the third engagement;
generating, by the computer, a set of suggestions for the second user based on the analysis of the set of historical interactions; and
rendering, by the computer, the set of suggestions on a second user device associated with the second user.

13. The computer-implemented method of claim 12, wherein the set of suggestions comprises at least one of a product suggestion, a preferred service option, a promotion, or an optimal duration for interaction.

14. A computer system, comprising:
a processor set;
one or more computer-readable storage media; and
program instructions stored on the one or more computer-readable storage media, the program instructions executable by the processor set to cause the processor set to:
receive input data comprising a set of accessibility preferences associated with a first user of a set of users;
link a user profile of the first user with a set of customer profiles of the first user based on the input data, wherein the set of customer profiles is associated with a set of merchant entities;
determine a first location of a first user device associated with the first user is within a threshold distance of a second location of a first interactor associated with a first merchant entity of the set of merchant entities, wherein the determination that the first location is within the threshold distance of the second location is based on the linking of the user profile and the set of customer profiles;
apply a first machine learning (ML) model on the input data and first merchant data, wherein the first merchant data is associated with the first merchant entity;
generate a first set of instructions based on the application of the first ML model on the input data and the first merchant data, wherein the first set of instructions is generated for customization of a first interaction between the first user and the first interactor by the first interactor; and
render the first set of instructions to the first interactor for the customization of the first interaction.

15. The computer system of claim 14, wherein the program instructions further cause the processor set to:
receive a first feedback based on the first interaction;
train the first ML model on the first feedback and the first set of instructions; and
generate a second set of instructions based on the training of the first ML model on the first feedback and the first set of instructions, wherein the second set of instructions is generated to customize a second interaction between the first user and a second interactor by the second interactor, wherein the second interactor is associated with a second merchant entity of the set of merchant entities.

16. The computer system of claim 15, wherein the program instructions further cause the processor set to:
determine the first location is within the threshold distance of a third location of the second interactor, wherein the determination that the first location is within the threshold distance of the third location is based on the linking of the user profile and the set of customer profiles;
apply the trained first ML model on the input data and second merchant data, wherein the second merchant data is associated with the second merchant entity;
generate the second set of instructions based on the application of the trained first ML model on the input data and the second merchant data, wherein the second set of instructions is generated for the customization of the second interaction between the first user and the second interactor; and
render the second set of instructions to the second interactor for the customization of the second interaction.

17. The computer system of claim 15, wherein the program instructions further cause the processor set to:
generate an interaction report based on the first feedback; and
transmit the interaction report to a first electronic device associated with the first merchant entity.

18. The computer system of claim 14, wherein the program instructions further cause the processor set to:
apply a second ML model on historical input data comprising a plurality of accessibility preferences associated with the set of users; and
generate one or more clusters from the set of users based on the application of the second ML model on the historical input data.

19. The computer system of claim 18, wherein the program instructions further cause the processor set to:
determine a fourth location of a second user is within the threshold distance of the second location, wherein the second user is different from the set of users;
identify the second user is associated with a first cluster of the one or more clusters;
generate a third set of instructions based on the identification that the second user is associated with the first cluster, wherein the third set of instructions is generated for customization of a third interaction between the second user and the first interactor by the first interactor; and
render the third set of instructions to the first interactor for the customization of the third interaction.

20. A computer-program product for customizing interactions, the computer-program product comprising:
one or more computer-readable storage media; and
program instructions stored on the one or more computer-readable storage media to perform operations comprising:
receiving input data comprising a set of accessibility preferences associated with a first user of a set of users;
linking a user profile of the first user with a set of customer profiles of the first user based on the input data, wherein the set of customer profiles is associated with a set of merchant entities;
detecting a first engagement between the first user and a first interactor, wherein the first interactor is associated with a first merchant entity of the set of merchant entities based on the linking of the user profile and the set of customer profiles;
applying a first machine learning (ML) model on the input data and first merchant data, wherein the first merchant data is associated with the first merchant entity;
generating a first set of instructions based on the application of the first ML model on the input data and the first merchant data, wherein the first set of instructions is generated for customization of a first interaction between the first user and the first interactor by the first interactor; and
rendering the first set of instructions to the first interactor for the customization of the first interaction.
